(19) United States
(12) Patent Application Publication
(10) Pub. No.: US 2017/0046999 A1
(43) Pub. Date: Feb. 16, 2017

(54) DISPLAY DEVICE HAVING REDUCED SCAN SIGNAL DELAY AND DRIVING METHOD THEREFOR

(71) Applicant: SAMSUNG DISPLAY CO., LTD., Yongin-si (KR)

(72) Inventors: Dong Gyu KIM, Yongin-si (KR); Jae Hoon LEE, Yongin-si (KR)

(21) Appl. No.: 15/070,378

(22) Filed: Mar. 15, 2016

(30) Foreign Application Priority Data
Aug. 12, 2015 (KR) 10-2015-0113897

(51) Int. Cl. G09G 3/20

(52) U.S. Cl. CPC G09G 3/2092; G09G 2330/028

(57) ABSTRACT

A display device according to an exemplary embodiment of the present invention may include: a display unit including a plurality of pixels; a first scan driver positioned at a first side of the display unit and arranged to output at least one first scan signal to the display unit; a second scan driver positioned at a second side of the display unit and arranged to output at least one second scan signal to the display unit; a third scan driver positioned along at least a portion of a third side of the display unit and arranged to output at least one third scan signal to the display unit; and a data driver positioned at a fourth side of the display unit and arranged to transmit a data signal to the display unit.

### CROSS-REFERENCE TO RELATED APPLICATION

This application claims priority to, and the benefit of, Korean Patent Application No. 10-2015-0113897 filed on Aug. 12, 2015 in the Korean Intellectual Property Office, the entire contents of which are incorporated herein by reference in their entirety.

### BACKGROUND OF THE INVENTION

1. Field

Embodiments of the present invention relate generally to display devices. More specifically, embodiments of the present invention relate to display devices having reduced scan signal delay, and driving methods therefor.

2. Description of the Related Art

Display devices are required for computer monitors, televisions, mobile phones, and the like, and as such are currently widely used. Such display devices, which display an image using digital data, are classified into a cathode ray tube display device, a liquid crystal display (LCD), a plasma display panel (PDP), an organic light emitting diode (OLED) display, and the like. As display devices have grown in size and resolution, the amount of data transmitted and associated data transmission speeds have also increased.

A display device may include a display unit including a plurality of pixels, a data driver for applying a data signal to the display unit, and a scan driver that selects pixels of the display unit to apply the data signal to the selected pixels. The pixels of the display unit may be formed in an area in which a plurality of scan lines is formed in a row direction to transmit a scan signal, and a plurality of data lines is formed in a column direction to transmit a data signal. The display unit may emit light and display an image according to the scan signal, the data signal, and a power supply signal.

As a means for sequentially outputting the scan signal, the scan driver is connected to a plurality of scan lines to transmit the scan signal to a specific pixel row of the display unit. The data signal transmitted from the data driver is applied to the specific row of the display unit to which the scan signal is transmitted, and one frame is completed once all the rows are sequentially selected. In this case, the scan signal is received in the form of a pulse.

However, display devices having the structure as described above may exhibit slow response speed, since the plurality of pixels are connected to the scan lines and thus a resistive component and a capacitive component generated by the pixels cause the response time of the scan lines to slowly increase.

Particularly, as a size of the display device becomes larger and the number of pixels gradually increases, the resistive and capacitive components of the display unit further increase. The response speed for the scan signal is thus becoming a more critical issue over time.

### SUMMARY OF THE INVENTION

Embodiments of the present invention provide a display device capable of reducing a response delay for a scan signal, as well as a corresponding driving method.

In addition, embodiments of the present invention provide a method for reducing a total RC for a charge rate of 99% while maintaining the same metal thickness.

Further, embodiments of the present invention provide a method for reducing a thickness of a scan line, and provide a display device without image quality deterioration associated with a voltage change of a data line, as well as associated driving methods.

Further, embodiments of the present invention provide a method for minimizing deterioration in yield by including an additional built-in circuit.

Technical objects desired to be achieved in the present invention are not limited to the aforementioned objects, and other technical objects not described above will be apparent to those skilled in the art from the disclosure of the present invention.

In order to achieve these and other objectives, a display device according to an exemplary embodiment of the present invention includes: a display unit including a plurality of pixels; a first scan driver positioned at a first side of the display unit and arranged to output at least one first scan signal to the display unit; a second scan driver positioned at a second side of the display unit and arranged to output at least one second scan signal to the display unit; a third scan driver positioned along at least a portion of a third side of the display unit and arranged to output at least one third scan signal to the display unit; and a data driver positioned at a fourth side of the display unit and arranged to transmit a data signal to the display unit.

The first and second scan drivers may be positioned to face each other.

The third scan driver and the data driver may be positioned to face each other.

The display device may further include: a plurality of first scan lines for transmitting at least one of the first and second scan signals from the first and second scan drivers to the display unit; and a plurality of second scan lines for transmitting the third scan signal from the third scan driver to the display unit. The second scan lines may be respectively connected to corresponding first scan lines.

The second scan lines may be connected to respective first scan lines in one-to-one correspondence.

The number of the first scan lines may be the same as that of the second scan lines.

A length of each of the plurality of second scan lines may sequentially increase with decreasing distance to an edge of the display unit.

Connecting points between the second scan lines and the first scan lines may collectively extend in a direction from the third side of the display unit to the fourth side thereof, and from a central part thereof to an edge thereof.

The second scan lines may be respectively sequentially connected to the first scan lines from the central part thereof to an edge thereof.

An out enable (OE) time of at least one of the first, second, and third scan signals may sequentially increase from the third side to the fourth side.

The OE time may be according to a resistance and a capacitance that are formed in each of the first scan lines.

In each of the first scan lines, points having the greatest scan RC values may be a midpoints between intersections of the first scan lines and the corresponding second scan lines, and respective connections between the first scan driver and the first scan lines.

The display device may further include a controller arranged to output a first scan control signal for controlling the first scan driver, a second scan control signal for controlling the second scan driver, and a third scan control signal for controlling the third scan driver.

Wires though which the controller is arranged to provide the third scan control signal to the third scan driver may extend from wires through which the controller is arranged to provide at least one of the first and second scan control signals to the corresponding first and second scan drivers.

The third scan driver may extend along one half to one third of the third side of the display unit.

Further, a method of driving the display device according to an exemplary embodiment of the present invention includes: outputting at least one first scan signal along a first direction of a plurality of first scan lines, the scan lines being connected to a display unit and extending in a row direction; outputting at least one second scan signal along a second direction of the plurality of first scan lines, the second direction being opposite to the first direction; and outputting at least one third scan signal along a column direction of a plurality of second scan lines connected to the display unit. The second scan lines may be respectively connected to corresponding first scan lines, and an out enable (OE) time of at least one of the first, second, and third scan signals may sequentially increase from a top side of the display unit to a bottom side thereof.

According to the exemplary embodiment of the present invention, display devices may be constructed with reduced scan signal response delay.

With the same metal thickness, a total RC for achieving a 99% charge rate may be reduced to about 0.625 times the total RC of the related art.

In addition, in the current exemplary embodiment of the present invention, scan resistance can be doubled to make the total RC in the last row 1.8 μs (1.8 μs+0.0 μs), thereby having an effect of reducing a thickness of the scan line to a half of that of the related art.

In addition, since a built-in circuit is not present at a lower side, image quality deterioration due to a change in voltage of the data line may not occur.

In addition, an additional built-in circuit may be realized as only a single unit at a top surface of the display unit, thereby minimizing deterioration in yield.

The above effects desired to be achieved in the present invention are not limited to the aforementioned effects, and other effects not described above will be apparent to those skilled in the art from the disclosure of the present invention.

### BRIEF DESCRIPTION OF THE DRAWINGS

FIG. 1 illustrates one example of a structure of a display device.

FIG. 2 illustrates an example of a structure of a display device according to an exemplary embodiment of the present invention.

FIG. 3 illustrates an example of a wiring diagram of a display unit according to the exemplary embodiment of the present invention.

FIG. 4 illustrates an example of a timing diagram of a scan signal and a data signal according to the exemplary embodiment of the present invention.

FIG. 5 illustrates another example of a timing diagram of a scan signal and a data signal according to the exemplary embodiment of the present invention.

### DETAILED DESCRIPTION OF THE EMBODIMENTS

Hereinafter, exemplary embodiments of the present specification will be described in detail with reference to the attached drawings.

In describing exemplary embodiments, a description of technical details, which are well-known to technical fields to which the exemplary embodiment of the present specification belongs and which are not directly related to the exemplary embodiments of the present specification, will be omitted. This is to more clearly convey not obscure the subject matter of the present invention by eliminating the unnecessary description.

In the present specification, it is to be understood that when one component is referred to as being “connected” or “coupled” to another component, it may be connected or coupled directly to another component or be connected or coupled to another component with one or more other components intervening therebetween. In addition, unless explicitly described to the contrary, the word “comprise” or “comprising”, will be understood to imply the inclusion of stated components but not the exclusion of any other components, so the additional components can be included in embodiments or the spirit and scope of the present invention.

Terms including ordinal numbers such as first, second, and the like, will be used only to describe various components, and are not interpreted as limiting these components. The terms are only used to differentiate one component from other components. For example, without departing from the scope of the present invention, the first component may be named the second component, and similarly, the second component may also be named the first component.

The component parts are independently shown in the embodiments of the present invention only to indicate the different characteristics, it does not mean that the component parts are made up of a separate hardware or a software unit. That is, respective component parts are arranged and included for convenience of explanation, so at least two component parts may make up one component part, or one component part may be separated into a plurality of component parts to perform a specific function. The integrated and separated exemplary embodiments of each component part are included in the scope of the present invention without departing from the spirit of the invention.

In addition, some of the components may be optional components only to improve the performance, not the essential components that perform essential functions in the present invention. The present invention can only be implemented by including only the essential component parts for implementing the essence of the present invention except for the components that are used only to enhance the performance, and a structure including only the required components except the optional components that are used only for performance improvement is also included in the spirit and scope of the invention.

Hereinafter, in describing exemplary embodiments of the present specification, the related well-known functions or constructions will not be described in detail when they may unnecessarily obscure the gist of the exemplary embodiment of the present invention. Hereinafter, exemplary embodiments of the present specification will be described with reference to the attached drawings. Further, the following terminologies are defined in consideration of the functions in the present invention and may be construed in different ways by the intention of users and operators, practice, or the like. Therefore, the definitions thereof should be construed based on the contents throughout the specification.

The various Figures are not necessarily to scale. All numerical values are approximate, and may vary. All examples of specific materials and compositions are to be taken as nonlimiting and exemplary only. Other suitable materials and compositions may be used instead.

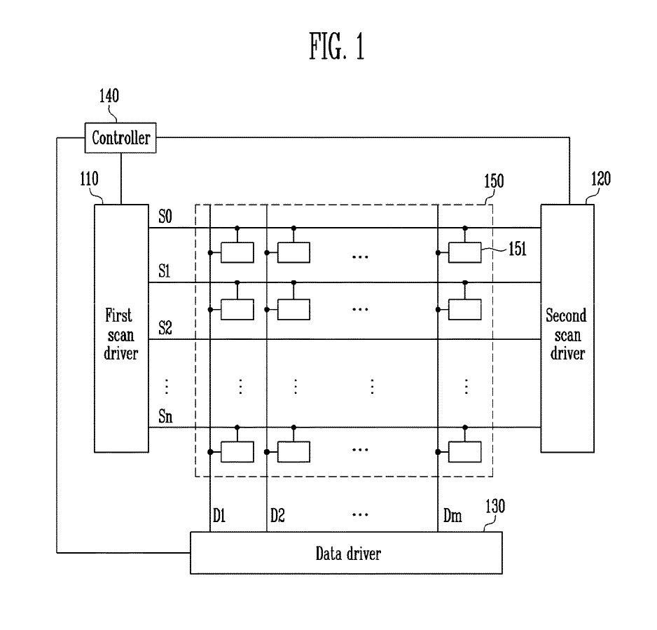

FIG. 1 illustrates an example of a structure of a display device.

Referring to FIG. 1, the display device may include a display unit 150 including a plurality of pixels 151; first and second scan drivers 110 and 120 for transmitting a plurality of scan signals to the display unit 150; a data driver 130 for transmitting a plurality of data signals to the display unit 150; a power supply unit (not shown) for supplying a driving voltage, e.g., a first power supply voltage ELVDD and a second power supply voltage ELVSS, to the display unit 150; and a controller 140 for supplying a plurality of control signals for controlling the first scan driver 110, the second scan driver 120, the data driver 130, and the power supply unit (not shown).

The display unit 150 is a panel in which the plurality of pixels 151 are arranged in a matrix form, and each of the pixels 151 may include an organic light emitting diode (OLED) that emits light corresponding to a flow of a driving current associated with the data signal transmitted from the data driver 130. In addition, according to a driving method of the OLED, the display device may be classified as a passive matrix type of organic light emitting diode (PMOLED) display or an active matrix type of organic light emitting diode (AMOLED) display. In some exemplary embodiments, the display device may be an AMOLED display. These are, however, merely representative examples, and the display unit 150 may be any type of display, OLED, LCD, or otherwise.

In each of the plurality of pixels 151 included in the display unit 150, a plurality of scan lines S0 to Sn are formed in a row direction to transmit the scan signals from the first scan driver 110 and the second scan driver 120. Also, a plurality of data lines D1 to Dm are formed in a column direction to transmit the data signal from the data driver 130. Thus, one of the plurality of pixels 151 positioned in a j-th pixel row and a k-th pixel column may be connected to one corresponding scan line and data line.

The pixels 151 include a pixel circuit that supplies a current associated with the corresponding data signal to the OLED, and the OLED may emit light of a predetermined luminance according to the supplied current. In this case, the first power supply voltage ELVDD and the second power supply voltage ELVSS which operate the display panel 150 may be transmitted from the power supply unit (not shown).

The first scan driver 110 and the second scan driver 120 may be connected to the plurality of scan lines S0 to Sn, such that they respectively transmit a first scan signal and a second scan signal to the corresponding scan lines S0 to Sn. The pixel 151 selected by the first scan signal and the second scan signal may receive the data signal supplied from the data driver 130 via the data lines D1 to Dm, to generate a current corresponding to the received data signal.

The data driver 130 is positioned at one side of the display unit 150, and may receive digital video data from controller 140, convert it to a data signal, and provide the data signal to the data lines D1 to Dm. In this case, the data driver 130 may be mounted on a substrate along with the display unit 150, or may be provided outside the substrate.

The first and second scan drivers 110 and 120 are positioned at opposite sides of the display unit 150, and generate scan control signals supplied from the controller 140, i.e., the scan signals for sequentially driving the scan lines S0 to Sn in response to a start signal and a clock signal. That is, the scan drivers 110, 120 sequentially provide received scan signals to their respective scan lines S0 to Sn. In this case, the first scan driver 110 may output the first scan signal, and the second scan driver 120 may output the second scan signal. In some exemplary embodiments, one scan signal is made up of the first scan signal and the second scan signal, and the pixel may be selected by the scan signal. Alternatively, the pixel may be selected by each of the first and second scan signals.

The controller 140 may output a first control signal for controlling the first scan driver 110 and a second control signal for controlling the second scan driver 120. The first and second scan drivers 110 and 120 are turned on by the first and second control signals to output the first and second scan signals, respectively.

In this case, the first and second scan drivers 110 and 120 may be positioned at opposite sides of the display unit 150 to transmit the first and second scan signals via one scan line. This configuration helps solve the problem of the scan signal being delayed by a resistive component and a capacitive component of the display unit 150 when transmitted to the pixels which are far away from the scan driver, since the scan signal is transmitted from both sides of the scan line.

For example, when only the first scan driver 110 is present, a pixel positioned farthest from the first scan driver 110, i.e., a pixel positioned at the rightmost column of the display unit 150 in FIG. 1, has a large delay associated with its scan signal due to a resistive component and a capacitive component that are formed in the pixel connected to the scan line. In this case, the second scan driver 120 is positioned to scan the second scan signal such that the scan signals of pixels positioned farthest from the first scan driver 110 can be prevented from being delayed.

However, as shown in FIG. 1, even when the first and second scan drivers 110 and 20 are positioned at left and right sides of the display unit 150, the scan signal may be delayed for pixels positioned at a central part of the display unit 150. As a size of the display device becomes larger and the number of pixels increases, i.e., as the resistive component and the capacitive component of the display unit of the large display device further increase, a response speed for the scan signal may be further delayed.

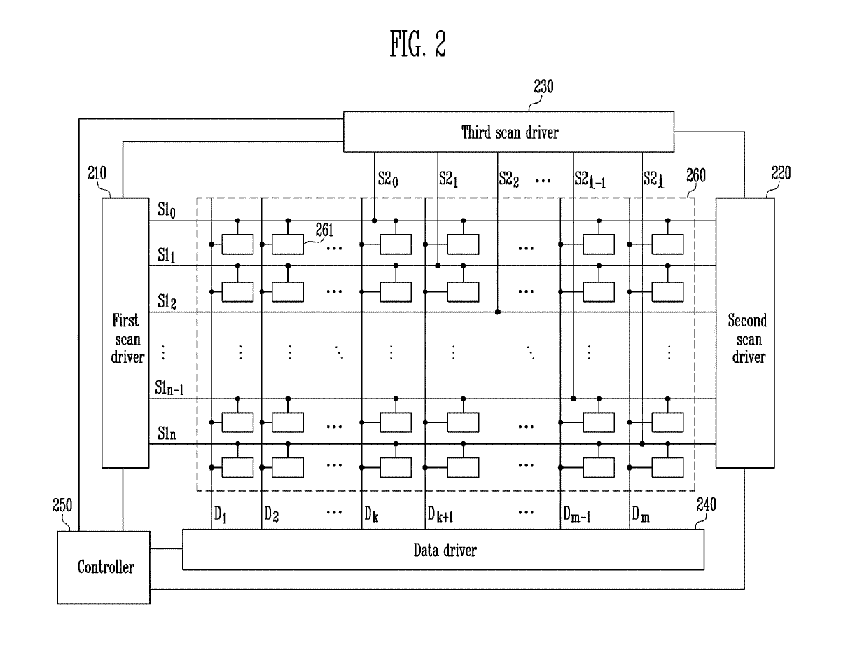

FIG. 2 illustrates an example of a structure of a display device according to an exemplary embodiment of the present invention.

Referring to FIG. 2, the display device according to the current exemplary embodiment of the present invention may include: a display unit 260 including a plurality of pixels 261; first, second, and third scan drivers 210, 220, and 230 for transmitting a plurality of scan signals to the display unit 260; a data driver 240 for transmitting a plurality of data signals to the display unit 260; a power supply unit for supplying a first power supply voltage ELVDD and a second power supply voltage ELVSS to the display unit 260 (not shown); and a controller 250 for supplying a plurality of control signals for controlling the first scan driver 210, the second scan driver 220, the third scan driver 230, the data driver 240, and the power supply unit (not shown).

The display unit 260 is a panel in which a plurality of pixels 261 are arranged in a matrix form, and each pixel 261 may include an OLED that emits light corresponding to a flow of a driving current associated with the data signal transmitted from the data driver 240. In addition, the display device may be classified into a passive matrix type of organic light emitting diode (PMOLED) display or an active matrix type of organic light emitting diode (AMOLED) display. In some exemplary embodiments, the display device may be an AMOLED display. In addition, the display unit 260 may have a shape in which a horizontal length is longer than a vertical length, and for example, a ratio of the vertical length to the horizontal length may be 16:9, 21:9, and 2:1, although the shape is not limited thereto and any shape and dimensions are contemplated.

The pixels 261 are connected to a plurality of first scan lines S1₀, S1₁, . . . , and S1ₙ formed in a row direction to transmit the scan signals from the first and second scan drivers 210 and 220, and to a plurality of data lines D₁, D₂, . . . , Dₖ, Dₖ₊₁, . . . , Dₘ₋₁, and Dₘ formed in a column direction to transmit a data signal from the data driver 240. In addition, a plurality of second scan lines S2₀, S2₁, . . . , and S2ₗ for transmitting the scan signals from the third scan driver 230 may be further included. The third scan driver 230 and the second scan lines S2₀, S2₁, . . . , and S2ₗ will be described later in more detail. The first scan lines S1₀, S1₁, . . . , and S1ₙ may be referred to as horizontal scan lines, while the second scan lines S2₀, S2₁, . . . , and S2ₗ may be referred to as vertical scan lines.

The pixels 261 include a pixel circuit that supplies a current associated with the corresponding data signal to the OLED, and the OLED may emit light of a predetermined luminance according to the supplied current. In this case, the first power supply voltage ELVDD and the second power supply voltage ELVSS required to operate the display panel 260 may be transmitted from the power supply unit (not shown).

The first scan driver 210, the second scan driver 220, and the third scan driver 230 operate to apply the plurality of scan signals to the display unit 260. The first and second scan drivers 210 and 220 may respectively transmit first and second scan signals to individual corresponding first scan lines S1₀, S1₁, . . . , and S1ₙ while being connected to the plurality of first scan lines S1₀, S1₁, . . . , and S1ₙ. In addition, the third scan driver 230 may transmit a third scan signal to individual corresponding second scan lines S2₀, S2₁, . . . , and S2ₗ. while being connected to the plurality of second scan lines S2₀, S2₁, . . . , and S2ₗ.

The pixels 261 selected by the first, second, and third scan signals may receive the data signal supplied from the data driver 240 via the data lines D₁, D₂, . . . , Dₖ, Dₖ₊₁, . . . , Dₘ₋₁, and Dₘ, and may generate a current corresponding to the data signal.

The data driver 240 is positioned at a fourth side of the display unit 260, and may receive digital video data from controller 250, convert it to a data signal, and supply the data signal to the data lines D₁, D₂, . . . , Dₖ, Dₖ₊₁, . . . , Dₘ₋₁, and Dₘ. In this case, the data driver 240 may be mounted on a substrate of the display unit 260, or may be provided outside the substrate. In some exemplary embodiments, the fourth side of the display unit 260 at which the data driver 240 is positioned may be a bottom side of the display unit 260.

The first and second scan drivers 210 and 220 may be positioned at first and second sides of the display unit 260. The first and second scan drivers 210 and 220 may generate scan control signals supplied from the controller 250, i.e., first and second scan signals for sequentially driving the plurality of first scan lines S1₀, S1₁, . . . , S1ₙ in response to a start signal and a clock signal, and may sequentially supply them to the plurality of first scan lines S1₀, S1₁, . . . , S1ₙ. In this case, the first scan driver 210 may output the first scan signal, and the second scan driver 220 may output the second scan signal. The scan control signal may include first and second scan control signals that respectively control the first and second scan drivers 210 and 220. In some exemplary embodiments, the first scan driver 210 may be positioned at the first side of the display unit 260, and the second scan driver 220 may be positioned at the second side of the display unit 260 facing the first side of the display unit 260. The first side and the second side may refer to left and right sides of the display unit 260.

On the other hand, the third scan driver 230 may be positioned along at least a portion of a third side of the display unit 260. The third scan driver 230 may generate a third scan control signal, i.e., the third scan signal for sequentially driving the second scan lines S2₀, S2₁, . . . , and S2ₗ, in response to the start signal and the clock signal supplied from the controller 250, and may sequentially supply them to the plurality of second scan lines S2₀, S2₁, . . . , and S2ₗ. In some exemplary embodiments, the third scan driver 230 may be formed along about one half to about one third of the third side of the display unit 260. For example, the third scan driver 230 may be formed along about one half of the third side of the display unit 260 to extend from a center part of the display unit 260 to an edge thereof. In some exemplary embodiments, the data driver 240 may be positioned at the fourth side of the display unit 260, and the third scan driver 230 may be positioned at the third side thereof, facing the fourth side of the display unit 260. The third side may refer to a top or upper surface or edge of the display unit 260. FIG. 2 illustrates an example in which the third scan driver 230 is formed along a rightmost half of the top side of the display unit 260, but embodiments of the invention are not limited thereto. For example, the third scan driver 230 may be formed along a leftmost half of the top side of the display unit 260, or may be formed along one third of the top surface of the display unit 260 along the rightmost half thereof.

The plurality of second scan lines S2₀, S2₁, . . . , and S2ₗ may respectively be connected to at least one of the plurality of corresponding first scan lines S1₀, S1₁, . . . , and S1ₙ. In some exemplary embodiments, the plurality of second scan lines S2₀, S2₁, . . . , S2ₗ may be connected to the plurality of first scan lines S1₀, S1₁, . . . , S1ₙ in one-to-one correspondence. The number (l) of the plurality of second scan lines S2₀, S2₁, . . . , S2ₗ may be the same as the number (n) of the plurality of first scan lines S1₀, S1₁, . . . , S1ₙ (l=n), although tis need not necessarily be the case. In some exemplary embodiments, a length of each of the plurality of second scan lines S2₀, S2₁, . . . , S2ₗ may sequentially increase with distance from the center part of the display unit 260 (i.e. the lengths of second scan lines S2₀, S2₁, . . . , S2ₗ may decrease with distance from edges of the display unit 260). In this case, the plurality of second scan lines S2₀, S2₁, . . . , and S2ₗ may be sequentially connected to the plurality of first scan lines S1₀, S1₁, . . . , and S1ₙ from an area located farthest from the first and second scan drivers 210 and 220, i.e., the center part of the display unit 260, to a side closest to either one of the first and second scan drivers 210 and 220, i.e., the edge of the display unit 260. For example, in this case, the (2-0)-th scan line S2₀ may be connected to the (1-0)-th scan line S1₀ that is formed at the third side of the display unit 260. The (2-m)-th scan line S2ₘ may be connected to the (1-n)-th scan line S1ₙ that is formed at the fourth side of the display unit 260. That is, when the third side is a top side of the display unit 260 and the fourth side is a bottom surface of the display unit 260, connecting points between the second scan lines S2₀, S2₁, . . . , and S2ₗ and the first scan lines S1₀, S1₁, . . . , and S1ₙ may be formed in a diagonal direction from a top side of the center part of the display unit 260 to a bottom side of the edge thereof.

In some exemplary embodiments, one scan signal may be completed by the first, second, and third scan signals, and the pixel may be selected by the first to third scan signals. Alternatively, the pixel may be selected by any one or more of the first, second, and third scan signals.

The controller 250 may output a first scan control signal for controlling the first scan driver 210, a second scan control signal for controlling the second scan driver 220, and a third scan control signal for controlling the third scan driver 230. The first, second, and third scan drivers 210, 220, and 230 may be turned on by the first, second, and third scan control signals to output the first, second, and third scan signals, respectively.

After receiving the corresponding scan signals, the selected pixels 261 included in the display unit 260 may accordingly allow the OLED to emit light with a data voltage corresponding to the data signal, thereby displaying an image.

However, though not illustrated, in some exemplary embodiments, wires through which the first, second, and third scan control signals are supplied to the first, second, and third scan drivers 210, 220, and 230 may be further extended from the same wires. That is, the wires supplying the third scan control signal to the third scan driver 230 may be further extended from the wires supplying the first scan control signal and/or the second scan control signal to the first scan driver 210 and/or the second scan driver 220.

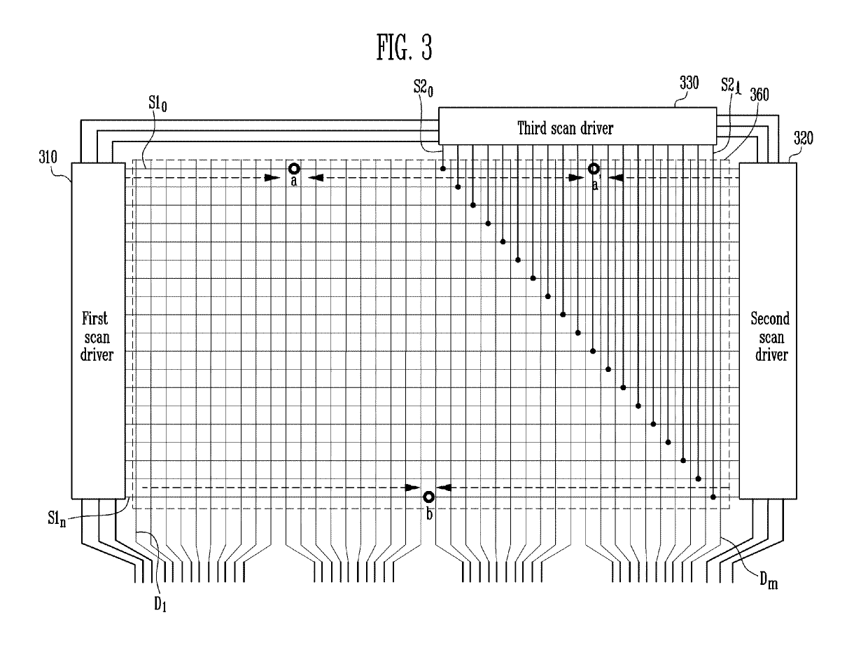

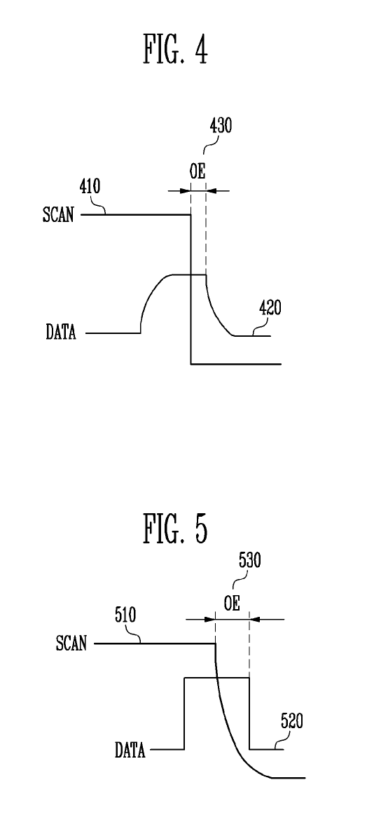

FIG. 3 illustrates an example of a wiring diagram of a display unit according to an exemplary embodiment of the present invention, FIG. 4 illustrates an example of a timing diagram of a scan signal and a data signal according to the exemplary embodiment of the present invention, and FIG. 5 illustrates another example of a timing diagram of a scan signal and a data signal according to the exemplary embodiment of the present invention.

Referring to FIG. 3, a first scan driver 310 is positioned at a first side of a display unit 360 according to the current exemplary embodiment of the present invention, and a second scan driver 320 may be positioned at a second side of the display unit 360 that faces the first scan driver 310. The first and second scan drivers 310 and 320 are connected to a plurality of first scan lines S1₀ to S1ₙ extending in a row direction of a plurality of pixels included in the display unit 360, i.e., in a direction from the first side of the display unit 360 to the second side thereof, to transmit a first scan signal and a second scan signal, respectively. A data driver (not shown) may be positioned at a fourth side of the display unit 360. The data driver (not shown) may be connected to a plurality of data lines D₁ to Dₘ formed in a column direction of the plurality of pixels included in the display unit 360, i.e., in a direction from a fourth side of the display unit 360 to a third side thereof, to transmit data signals.

A third scan driver 330 may be disposed along at least part of the fourth side of the display unit 360. The third scan driver 330 may be connected to a plurality of second scan lines S2₀ to S2ₗ which extend in the column direction of the plurality of pixels included in the display unit 360, i.e., in a direction from the third side of the display unit 360 to the fourth side, to transmit a third scan signal. In some exemplary embodiments, the third scan driver 330 may be formed along about one half to about one third of the third side of the display unit 360. For example, the third scan driver 330 may be formed along about one half of the third side of the display unit 260 from a center part of the display unit 360 to an edge thereof.

The second scan lines S2₀ to S2ₗ may be respectively connected to at least one of the corresponding first scan lines S1₀ to S1ₙ. In some exemplary embodiments, the second scan lines S2₀ to S2ₗ and the first scan lines S1₀ to S1ₙ may be connected in one-to-one correspondence. In this case, the number (l) of the second scan lines S2₀ to S2ₗ and the number (n) of the first scan lines S1₀ to S1ₙ may be identical (l=n). In some exemplary embodiments, a length of each of the plurality of second scan lines S2₀ to S2ₗ may sequentially increase with proximity to the edge of the display unit 360. In this case, connecting points between the plurality of second scan lines S2₀ to S2ₗ and the plurality of first scan lines S1₀ to S1ₙ may be formed in a direction from the third side of the display unit 360 to the fourth side thereof closer to the edge of the display unit 360. That is, the plurality of second scan lines S2₀ to S2ₗ may be sequentially connected the plurality of first scan lines S1₀ to S1ₙ from a side located farthest from the first and second scan drivers 310 and 320, i.e., the center part of the display unit 360, to a side closest to either one of the first and second scan drivers 310 and 320, i.e., an edge of the display unit 360.

Wires supplying a third scan control signal to the third scan driver 330 may be, as illustrated in the drawing, further extended from the wires that supply the first scan control signal and/or the second scan control signal to the first scan driver 310 and/or the second scan driver 320.

In this case, the third scan driver 330 may sequentially increase an out enable (OE) time of the third scan signal closer to the fourth side of the display unit 360. That is, the third scan driver 330 may sequentially increase the OE time of the third scan signals closer to the scan line formed at the edge of the display unit 360 (i.e., the (2-l)-th scan line) relative to the scan line formed in the center part of the display unit 360 (i.e., the (2-0)-th scan line). In this case, the OE time refers to a driving timing in which an off-time of a waveform of the scan signal precedes an off-time of a waveform of the data signal. In some exemplary embodiments, the OE time may be determined by resistance and capacitance that are generated in the scan line. For example, the OE time may be determined to a value that is obtained by dividing a product of resistance and capacitance formed in the first scan line by 4 (OE time=R*C/4).

Referring to FIG. 4, one example of a timing diagram of a scan signal and a data signal in the (1-0)-th scan line S1₀ formed at the top side of the display unit 360 is illustrated. As illustrated, in the center part of the display unit 360, the third scan driver 330 may make an OE time 430 of a (3-0)-th scan signal 410 shorter. That is, an off-time of the (3-0)-th scan signal 410 may precede an off-time of the data signal 420 by a short duration of time. Since the (2-0)-th scan line S2₀ is connected to the (1-0)-th scan line S1₀ at the center part of the display unit 360, resistance and capacitance formed in the (1-0)-th scan line S1₀ are small. Thus, since the (3-0)-th scan signal 410 supplied to the (2-0)-th scan line S2₀ experiences a short delay in response speed due to the resistance and capacitance that are formed by the (1-0)-th scan line S1₀, supply of the (3-0)-th scan signal 410 may be stopped without experiencing a delay in a response speed when the (3-0)-th scan signal 410 is off. Accordingly, even when the OE time of the (3-0)-th scan signal 410 becomes shorter, a discharge rate of the (3-0)-th scan signal 410 may be sufficiently secured. In this case, the OE time may be determined by the resistance and capacitance that are formed by the (1-0)-th scan line S10.

Referring to FIG. 5, one example of a timing diagram of a scan signal and a data signal in the (1-n)-th scan line S1ₙ formed at the bottom side of the display unit 360 is illustrated. As illustrated, the third scan driver 330 may have a longer OE time 530 of the (3-l)-th scan signal 510 than an OE time 430 of the (3-0)-th scan signal 410. That is, an off-time of the (3-l)-th scan signal 510 may precede an off-time of the data signal 520 by a long duration of time. Since the (2-l)-th scan line S2ₗ formed at the edge of the display unit 360 is connected to the (1-n)-th scan line S1ₙ formed around the fourth side of the display unit 360, resistance and capacitance formed in the (1-n)-th scan line S1ₙ may be relatively large. Accordingly, since the (3-l)-th scan signal 510 supplied to the (2-l)-th scan line S2ₗ may experience a large delay in its response speed due to the resistance and capacitance that are formed by the (1-n)-th scan line S1ₙ, supply of the (3-l)-th scan signal 510 may be more smoothly stopped when the (3-l)-th scan signal 510 is off. Therefore, in order to provide sufficient discharge time for the (3-l)-th scan signal 510, the OE time of the (3-l)-th scan signal 510 should be extended. In this case, the OE time may be determined by the resistance and capacitance that are formed in the (1-n)-th scan line S1ₙ.

OE times of the (3-1)-th scan signal 510 and the (3-(l−1))-th scan signal may sequentially increase from the OE time of the (3-0)-th scan signal. OE times of the scan signals respectively supplied from the (2-1)-th to the (2-(l−1))-th scan lines S2₁ to S2ₗ₋₁ may be determined by resistances and capacitances that are respectively formed in the connected first scan lines S1₁ to S1ₙ₋₁.

Referring to FIG. 3 to FIG. 5, a case in which the OE time of the third scan signal supplied from the third scan driver 330 sequentially increases closer to the fourth side of the display unit 360 from the third side thereof has been described, but the OE time of the first scan signal supplied from the first scan driver 310 and the OE time of the second scan signal supplied from the second scan driver 320 may also sequentially increase closer to the fourth side from the third side. That is, the first scan driver 310 may be configured to sequentially increase the OE times such that the OE time of the (1-0)-th scan signal supplied to the (1-0)-th scan line S1₀ is shortest and the OE time of the (1-n)-th scan signal provided to the (1-n)-th scan line S1ₙ is longest. The first scan driver 320 may be configured to sequentially increase the OE times such that the OE time of the (2-0)-th scan signal supplied to the (1-0)-th scan line S1₀ is shortest and the OE time of the (2-n)-th scan signal supplied to the (1-n)-th scan line S1ₙ is longest. That is, the scan signals supplied from the first, second, and third scan drivers 310, 320, and 330 may be determined by the resistances and capacitances that are formed by the connected first scan lines S1₀ to S1ₙ, respectively.

Referring back to FIG. 3, a point having the greatest scan RC in the (1-0)-th scan line S1₀, which is an uppermost one of the plurality of first scan lines S1₀ to S1ₙ of FIG. 3, is point a or a′. A point having the greatest scan RC in the (1-n)-th scan line S1ₙ, which is a lowermost scan line, is point b. In the rest of first scan lines S1₁ to S1ₙ₋₁ among the plurality of first scan lines S1₀ to S1ₙ, points having the greatest scan RC may be points that connect a with b or a′ with b.

Specifically, in first scan driver 310, the (1-0)-th scan signal is supplied in a direction from the first scan driver 310 to the second scan driver 320, whereas in second scan driver 320, the (2-0)-th scan signal is supplied in a direction from the second scan driver 320 to the first scan driver 310. In this case, when only the first scan driver 310 and the second scan driver 320 are present, the first scan signal and the second scan signal may experience greatest delays in first scan lines S1₀ to S1ₙ in the center part of the display unit 360. Accordingly, when only the first scan driver 310 and the second scan driver 320 are present, a point having the greatest scan RC may be located at a center column of the display unit 360.

However, as in the display device according to the current exemplary embodiment of the present invention where the third scan driver 330 is positioned at the third side of the display unit 360, the third scan signal may be supplied to the plurality of second scan lines S2₀ to S2ₗ. The third scan signal may then be supplied to the first scan lines S1₀ to S1ₙ via connections between those lines and the plurality of second scan lines S2₀ to S2ₗ. In this case, connecting points between the plurality of second scan lines S2₀ to S2ₗ and the plurality of first scan lines S1₀ to S1ₙ, as illustrated in FIG. 3, are exemplarily described such that they are formed closer to the fourth side of the display unit 360 from the third side thereof, while extending toward the edge of the display unit 360 from the center part thereof.

In this case, the (3-0)-th scan signal supplied to the (2-0)-th scan line S2₀ connected to a center of the (1-0)-th scan line S1₀ may thus be supplied to the (1-0)-th scan line S1₀ such that it is supplied in a direction toward the first and second scan drivers 310 and 320. Accordingly, the (1-0)-th scan signal and the (3-0)-th scan signal supplied to the (1-0)-th scan line S1₀ may have the greatest scan RC at point a, i.e. the point between where the (1-0)-th scan line S1₀ and the (2-0)-th scan line S2₀ meet (i.e., the center part of the display unit) and where the first scan driver 310 and the (1-0)-th scan line S1₀ are connected (i.e., the left side of the display unit). Likewise, the (2-0)-th scan signal and the (3-0)-th scan signal supplied to the (2-0)-th scan line S2₀ may have the greatest scan RC at a point (point a′) between where the (1-0)-th scan line S1₀ and the (2-0)-th scan line S2₀ meet (i.e., a center part of the display unit) and where the second scan driver 320 and the (1-0)-th scan line S1₀ are connected (i.e., the right side of the display unit).

The (3-l)-th scan signal supplied to the (2-l)-th scan line S2ₗ may be supplied to the (1-n)-th scan line S1ₙ connected to the (2-l)-th scan line S2ₗ, such that it is supplied in a direction toward the first and second scan drivers 310 and 320. In this case, since the (1-n)-th scan line S1ₙ and the (2-l)-th scan line S2ₗ are connected to each other near the second scan driver 320, the (3-l)-th scan signal supplied from the (2-l)-th scan line S2ₗ to the (1-n)-th scan line S1ₙ may be regarded such that only the signal supplied toward the first scan driver 310 is generated. That is, the signal applied to line S1n can be thought of as coming from either line S2l or the second scan driver 320, as the two are connected at such close proximity to each other. Accordingly, the (1-n)-th scan line S1ₙ may have the greatest scan RC at a center (i.e., point b in the center part of the display unit) between where the (1-n)-th scan line S1ₙ and the (2-l)-th scan line S2ₗ meet (i.e., the right side of the display unit) and where first scan driver 310 and the (1-n)-th scan line S1ₙ are connected (i.e., the left side of the display unit).

As described above, the first scan lines S1₀ to S1ₙ may respectively have their greatest scan RCs at centers between where the corresponding first scan lines S1₀ to S1ₙ and the corresponding second scan lines S2₀ to S2ₗ meet and where the first scan driver 310 and the corresponding first scan lines S1₀ to S1ₙ are connected. Alternatively, the first scan lines S1₀ to S1ₙ may respectively have the greatest scan RCs at midpoints between where the corresponding first scan lines S1₀ to S1ₙ and the corresponding second scan lines S2₀ to S2ₗ meet and where the second scan driver 320 and the corresponding first scan lines S1₀ to S1ₙ are connected.

In the display device according to the current exemplary embodiment of the present invention, the third scan driver 330 is formed along at least some of the third side of the display unit 360, and the second scan lines S2₀ to S2ₗ are respectively connected to the corresponding first scan lines S1₀ to S1ₙ, thereby decreasing the scan RC.

For example, as shown in Table 1, the point having the greatest scan RC and the OE time associated with the point may be changed.

TABLE 1

| | Conventional | Point with greatest |
|---|---|---|
| Item | center part | scan RC (a) |
| Scan R [kΩ] | 6.36 | 3.18 |
| Scan C [pF] | 564 | 282 |
| Scan 1/4 R*C (OE) [μs] | About 0.90 (Ref) | About 0.225 (1/4 Ref) |

Referring to Table 1, for example, in a 55-inch UHD display device, when only the first scan driver 310 and the second scan driver 320 are present, one example of scan R, scan C, and OE in the center part of the display unit 360 having the greatest scan RC are shown. When a third scan driver 330 is additionally present, a point having the greatest scan RC may be, as described above, a center (point a) between where the (1-0)-th scan line S1₀ and the (2-0)-th scan line S2₀ meet (i.e., the center part of the display unit) and where the first scan driver 310 and the (1-0)-th scan line S1₀ are connected (i.e., the left side of the display unit). In this case, values of R, C and OE at point ‘a’ are shown.

In this case, suppose the third scan driver 330 is formed across about one half of the display unit 360 from the center part of the display unit 360 to an edge thereof, as shown in FIG. 3. A distance from the first scan driver 310 to the point of the corresponding first scan line S1₀ having the greatest scan RC (i.e., point ‘a’) may thus be one half the distance from the first scan driver 310 to the center part of the display unit. Accordingly, scan R at point ‘a’ may be about one half the scan R of the center part of a conventional display unit with no third scan driver 330, and scan C at point ‘a’ may be about one half that of the center part of a conventional display unit. As a result, scan RC may be reduced to about one quarter ¼ the conventional scan RC. For example, when only the first and second scan drivers 310 and 320 are present, scan R of the center part of the display unit 360 may be about 6.36 kΩ, and scan C may be about 564 pF. Accordingly, scan RC of the center part may be about 0.90 μs. However, in the display device according to the current exemplary embodiment of the present invention, in the (1-0)-th scan line S1₀ of the plurality of first scan lines S1₀ to S1ₙ, scan R at point ‘a’ having the greatest scan RC may be about 3.18 kΩ and scan C may be about 282 pF. Accordingly, scan RC at point ‘a’ may be about 0.225 μs. Similarly, scan RCs of the rest of the (1-1)-th to the (1-n−1) scan lines S1₁ to S1ₙ₋₁ may be reduced as compared to conventional displays, since points having the greatest scan RCs are formed at points other than the center part of the display unit.

On the other hand, as described above, in the (1-n)-th scan line S1ₙ which is the last row of the plurality of first scan lines S1₀ to S1ₙ, the point having the greatest scan RC may be a center (i.e., point ‘b’ in the center part of the display unit) of where the (1-n)-th scan line S1ₙ and the (2-l)-th scan line S2ₗ meet (i.e., the right side of the display unit) and where the first scan driver 310 and the (1-n)-th scan line S1ₙ are connected (i.e., the left side of the display unit). Accordingly, a scan RC value in the (1-n)-th scan line S1ₙ may be the same as that when the greatest scan RC appears in the center part of the display unit. For example, the scan RC value in the (1-n)-th scan line S1ₙ may be about 0.90 μs in the example of Table 1.

That is, in the example of Table 1, when only the first and second scan drivers 310 and 320 are present, the center part of the display unit, where scan RC is greatest, exhibits an OE time of about 0.9 μs. On the contrary, according to the current exemplary embodiment of the present invention, when the third scan driver 330 is formed across about one half of the display unit 360 from the center part of the display unit 360 to an edge thereof, an OE time at point ‘a’ of the display unit where scan RC is greatest may be about 0.225 μs in the first row S1₀ of the plurality of first scan lines S1₀ to S1ₙ. An OE time at point ‘b’ of the display unit where scan RC is greatest may be about 0.9 μs in the last row S1ₙ of the plurality of first scan lines S1₀ to S1ₙ.

Data RC for the data signal may be assumed to be about 0.9 μs. In addition, data RC may be about 0.0 μs around the fourth side of the display unit, i.e., around the data driver (not shown). In this case, to achieve a 99% charge rate, a total RC condition is a sum of scan RC and data RC (total RC=scan RC+data RC). Thus, when only the first and second scan drivers 310 and 320 are present, a total OE time in the center part of the display unit where scan RC is greatest in the first row S1₀ may be about 1.8 μs, which is a sum of the scan RC of 0.9 μs and a data RC of 0.9 μs. On the contrary, according to the current exemplary embodiment of the present invention, when the third scan driver 330 is formed across about one half of the display unit 360 from the center part of the display unit 360 to an edge thereof, in the first row S1₀ of the plurality of first scan lines S1₀ to S1ₙ, a total OE time at point ‘a’ of the display unit where scan RC is greatest may be about 1.125 μs, which is a sum of the scan RC of 0.225 μs and the data RC of 0.9 μs. A total OE time at point ‘b’ of the display unit, where scan RC is greatest in the last row S1ₙ of the plurality of first scan lines S1₀ to S1ₙ, may be about 0.9 μs, which is a sum of the scan RC of 0.9 μs and the data RC of 0 μs.

That is, the OE time may be set to about 0.225 μs in the first row S1₀ of the first scan lines S1₀ to S1ₙ, and may be monotonically increased to about 0.90 μs in the last row S1ₙ. In this case, an overall RC including data RC may be reduced to about 1.125 μs compared to a previous value of about 1.80 μs.

As described above, in the display device according to the current exemplary embodiment of the present invention, the OE time of the scan signal may be sequentially increased closer to a bottom side of the display unit from a top side thereof.

According to the current exemplary embodiment of the present invention, with same metal thickness, a total RC for achieving a 99% charge rate may be reduced to about 0.625 times the total RC of the related art. In addition, in the current exemplary embodiment of the present invention, scan resistance should be doubled to make the total RC in the last row 1.8 μs (1.8 μs+0.0 μs), thereby having an effect of reducing a thickness of the scan line to a half compared to the related art. Further, since a lower built-in circuit is not present, deterioration in image quality due to a voltage change of the data line may not be generated. Further, only a single unit of additional built-in circuit may be implemented at the top side of the display unit, thereby minimizing deterioration in yield.

Example embodiments have been disclosed herein and although specific terms are employed, they are used and are to be interpreted in a generic and descriptive sense only and not for purpose of limitation. In some instances, as would be apparent to one of ordinary skill in the art as of the filing of the present application, features, characteristics and/or elements described in connection with a particular embodiment may be used singly or in combination with features, characteristics and/or elements described in connection with other embodiments unless otherwise specifically indicated. Accordingly, it will be understood by those of skill in the art that various changes in form and details may be made without departing from the spirit and scope of the present invention as set forth in the following claims. Various features of the above described and other embodiments can be mixed and matched in any manner, to produce further embodiments consistent with the invention.

What is claimed is:

1. A display device comprising:
a display unit including a plurality of pixels;
a first scan driver positioned at a first side of the display unit and arranged to output at least one first scan signal to the display unit;
a second scan driver positioned at a second side of the display unit and arranged to output at least one second scan signal to the display unit;
a third scan driver positioned along at least a portion of a third side of the display unit, the third scan driver arranged to output at least one third scan signal to the display unit; and
a data driver positioned at a fourth side of the display unit and arranged to transmit a data signal to the display unit.

2. The display device of claim 1, wherein the first and second scan drivers are positioned to face each other.

3. The display device of claim 1, wherein the third scan driver and the data driver are positioned to face each other.

4. The display device of claim 1, further comprising:
a plurality of first scan lines for transmitting at least one of the first and second scan signals from the first and second scan drivers to the display unit; and
a plurality of second scan lines for transmitting the third scan signal from the third scan driver to the display unit, wherein the second scan lines are respectively connected to corresponding first scan lines.

5. The display device of claim 4, wherein the second scan lines are connected to the respective first scan lines in one-to-one correspondence.

6. The display device of claim 4, wherein the number of the first scan lines is the same as that of the second scan lines.

7. The display device of claim 4, wherein a length of each of the plurality of second scan lines sequentially increases with decreasing distance to an edge of the display unit.

8. The display device of claim 4, wherein connecting points between the second scan lines and the first scan lines collectively extend in a direction from the third side of the display unit to the fourth side thereof, and from a central part thereof to an edge thereof.

9. The display device of claim 4, wherein the second scan lines are respectively sequentially connected to the first scan lines from the central part thereof to an edge thereof.

10. The display device of claim 4, wherein an out enable (OE) time of at least one of the first, second, and third scan signals sequentially increases from the third side to the fourth side.

11. The display device of claim 10, wherein the OE time is determined according to resistances and capacitances that are formed in each of the first scan lines.

12. The display device of claim 11, wherein points having the greatest scan RC values in each of the first scan lines are midpoints between intersections of the first scan lines and the corresponding second scan lines, and respective connections between the first scan driver and the first scan lines.

13. The display device of claim 1, further comprising a controller arranged to output a first scan control signal for controlling the first scan driver, a second scan control signal for controlling the second scan driver, and a third scan control signal for controlling the third scan driver, wherein wires though which the controller is arranged to provide the third scan control signal to the third scan driver extend from wires through which the controller is arranged to provide at least one of the first and second scan control signals to the corresponding first and second scan drivers.

14. The display device of claim 1, wherein the third scan driver extends along one half to one third of the third side of the display unit.

15. A method of driving a display device, the method comprising:
outputting at least one first scan signal along a first direction of a plurality of first scan lines, the first scan lines being connected to a display unit and extending in a row direction;
outputting at least one second scan signal along a second direction of the plurality of first scan lines, the second direction being opposite to the first direction; and
outputting at least one third scan signal along a column direction of a plurality of second scan lines connected to the display unit, wherein the second scan lines are respectively connected to corresponding first scan lines, and an out enable (OE) time of at least one of the first, second, and third scan signals sequentially increases from a top side of the display unit to a bottom side thereof.
